(19) United States
(12) Patent Application Publication
(10) Pub. No.: US 2018/0352584 A1
(43) Pub. Date: Dec. 6, 2018

(54) AUXILIARY RECEIVERS FOR QoS BALANCING IN WIRELESS COMMUNICATIONS

(71) Applicant: Microsoft Technology Licensing, LLC, Redmond, WA (US)

(72) Inventor: Amer Hassan, Kirkland, WA (US)

(73) Assignee: Microsoft Technology Licensing, LLC, Redmond, WA (US)

(21) Appl. No.: 15/613,015

(22) Filed: Jun. 2, 2017

(51) Int. Cl. H04W 76/02; H04W 24/02

(52) U.S. Cl. CPC H04W 76/025; H04W 88/08; H04W 24/02

(57) ABSTRACT

Auxiliary receivers are used to provide extra data redundancy and/or improved quality of service (QoS) for data transmissions sent on an uplink between a source device and a base station. In the embodiments, an auxiliary receiver may be used to intercept/receive uplink transmissions carrying a data stream from a source device that is transmitting to a base station, where the base station is forwarding the data stream on through a network to a destination device as a first data stream. Upon intercepting/receiving the uplink transmissions, the auxiliary receiver may send the intercepted/received data stream onward through the network to the same destination device as a second data stream that is redundant to the first data stream. The destination device may then process the redundant second data stream in conjunction with the first data stream using techniques that increase QoS associated with the first data stream at the destination device.

### BACKGROUND

Wireless communications used in media applications require a high quality of service (QoS) for transmissions sent from a source device to a destination device through a wireless network. This requirement holds true for both the wireless uplink connection from the source device to a first base station of the network and the wireless downlink connection from a second base station of the network to the destination device.

It is not uncommon that it may be the uplink connection from the source device to the first base station of the network that is the limiting factor on performance. For example, performance on the uplink connection may suffer due to the limited transmission power that is available when the source device is a small battery powered portable device, while the downlink connection may be provided abundant transmission power by the second base station of the network. Also, the fact that the second base station of the network is integrated into the network infrastructure may allow more efficient link and channel management on the downlinks. Most networks, therefore, exhibit unbalanced performance between the uplink and downlink for communications sent from a source device to a destination device.

### SUMMARY

This summary is provided to introduce a selection of concepts in a simplified form that are further described below in the Detailed Description. This summary is not intended to exclusively or exhaustively identify key features or essential features of the claimed subject matter. Nor is it intended as an aid in determining the scope of the claimed subject matter.

The embodiments of the disclosure provide systems, methods, and apparatus that utilize auxiliary receivers to provide extra data redundancy and/or improved quality of service (QoS) for data transmissions sent on an uplink between a source device and a base station. In the embodiments, an auxiliary receiver may be used to receive uplink data transmissions carrying a data stream from a source device that is transmitting to a base station, where the base station is forwarding the data stream onward through a network to a destination device as a first data stream. Upon receiving the uplink transmissions, the auxiliary receiver may send the intercepted/received data stream onward through the network to the same destination device as a second data stream that is redundant to the first data stream. The destination device may then process the redundant second data stream in conjunction with the first data stream using techniques that increase QoS associated with the first data stream at the destination device.

In one implementation, the auxiliary receiver may be implemented as part of a receiver in a first base station that also serves as a primary base station (i.e. a conventional base station) for one or more first devices. While serving as a primary base station, the first base station communicates on uplinks and downlinks with the one or more first devices and facilitates communications between the one or more first devices and a network. The network may also include one or more second devices each communicating on uplinks and downlinks with one or more second base stations. Receiver resources available to the first base station for use during operations as the auxiliary receiver may be reserved on a priority basis for use as a primary base station. During operation, the first base station may determine that it has available receiver resources and is able to serve as an auxiliary receiver. In response to the determination that it has available resources, the first base station may initiate operation as an auxiliary receiver. The first base station may scan uplink transmissions sent by one or more second devices to one or more second base stations in order to determine what channel or channels to receive data transmissions on as an auxiliary receiver, and determine what protocols or other parameters to use to receive on those channels. Based on the scan, the first base station may receive selected uplink transmissions including a data stream that is being sent through one of the second base stations as a first data stream to a destination device. Upon receiving the selected uplink transmissions, the auxiliary receiver may send the intercepted/received data stream onward through the network to the destination device as a second data stream that is redundant to the first data stream.

Alternatively, the first base station may receive a request for auxiliary resources from a selected base station of the one or more second base stations. The request for auxiliary resources may be associated with a selected uplink between the selected base station and a selected device of the one or more second devices. This request for auxiliary resources may be sent upon the determination in the selected base station that certain network conditions that negatively affect the quality of the selected uplink have occurred. Upon receiving the request for auxiliary resources, the first base station may send a response indicating whether or not it can meet the request. If the first base station can meet the request, the first base station may receive data transmissions including a data stream on the selected uplink and send the intercepted/received data stream onward through the network as a redundant data stream. In another alternative, the first base station may receive the request for auxiliary resources from the selected device of the one of the second devices or from a network apparatus, based on monitoring of the uplink quality performed at the selected device or network apparatus.

In another implementation, a first base station may transmit information in a beacon signal that alerts devices operating in a network of the ability of the first base station to operate as an auxiliary receiver. The information transmit in the beacon signal may include information about the capabilities of the first base station to operate as an auxiliary receiver. A device that receives the information in the beacon signal and that is sending data transmissions on an uplink to a second base station in the network may send a request for auxiliary resources to the first base station when the uplink becomes degraded or when the possibility of the link becoming degraded increases. Upon receiving the request, the first base station may receive the uplink transmissions from the device and send the intercepted/received data stream onward through the network to a destination device as a redundant data stream.

### BRIEF DESCRIPTION OF THE DRAWINGS

FIG. 1A is a diagram illustrating a system including an example base station operable as an auxiliary receiver;

FIG. 1B is a diagram illustrating another system including an example base station operable as an auxiliary receiver;

FIGS. 2A and 2B are simplified diagrams that illustrate example base stations configured according to an implementation of the disclosure;

FIG. 3 is a flow diagram of operations performed by the example base station of FIG. 2A;

FIG. 4 is a flow diagram of operations performed by the example base station of FIG. 2B;

FIG. 5 is a flow diagram of example operations performed by another implementation of the example base station of FIG. 2B;

FIG. 6A is a simplified block diagram showing another example base station operable as an auxiliary receiver;

FIG. 6B is a simplified block diagram showing an example device configured to request resources from an auxiliary receiver;

FIG. 7A is a flow diagram of operations performed by an example base station;

FIG. 7B is a flow diagram of example operations performed by an example device configured to request auxiliary resources from a base station;

FIG. 8 is a simplified block diagram showing an example device operable to request auxiliary resources;

FIG. 9 is a simplified block diagram showing an example base station including an auxiliary receiver; and,

FIG. 10 is a simplified block diagram showing another example base that is operable to request auxiliary resources.

### DETAILED DESCRIPTION

The systems, methods and apparatus will now be described by use of example embodiments. The example embodiments are presented in this disclosure for illustrative purposes, and not intended to be restrictive or limiting on the scope of the disclosure or the claims presented herein.

The embodiments of the disclosure provide systems, apparatus, and methods that allow a first base station to be configured to operate as an auxiliary receiver for data transmissions sent on an uplink from a source device to a second base station. The second base station may be engaged in conventional 2-way communications with the source device, for example, on uplink and downlink channels. A first base station operating as an auxiliary receiver according to the embodiments may be used to provide extra data redundancy to improve quality of service (QoS) associated with a primary data stream sent on the uplink from the source device to the second base station, and then onward through a network to a destination device. A redundant data stream forwarded from the auxiliary receiver may be utilized to enhance overall performance and quality of the data at the destination device. For example, data combining techniques may be used in the destination device to combine the primary data stream and the redundant data stream. In other implementations, the data combining may be performed elsewhere along the transmission path, such as at a destination base station that sends the combined data streams to the destination device over a downlink channel.

The first base station may operate as an auxiliary receiver and/or as a primary base station. When operating as a primary base station, the first base station provides conventional uplink/downlink communications for one or more devices, depending on receiver resource availability. If the receiver resources of the first base station are needed for operation as a primary base station, the first base station may operate as a primary base station only. When the first base station has available resources that are not needed for operation in primary mode, it may initiate operation as an auxiliary receiver.

When the first base station operates as an auxiliary receiver, the first base station receives data transmissions sent on the uplink from the source device to the second base station and generates a first data stream from the received data transmissions. The first base station may then send the first data stream onward through a network, as a redundant data stream. The first base station does this concurrently with the second base station receiving the data transmissions, generating a second data stream from the data transmissions and sending the second data stream onward through the network to a destination device as the primary or original data stream. The destination device receives both the first data stream from the first base station and the second data stream sent through the network from the second base station. The redundancy provided by the first data stream allows the destination device to improve the QoS associated with the second data stream. When the first base station is not operating as an auxiliary receiver, the receiver in the destination device may receive only the second data stream from the second base station.

A first base station including an auxiliary receiver according to the disclosed implementations provides an advantage in that the auxiliary receiver may be used as a redundant receiver on the uplink portion of a transmission path between a source device and a destination device to improve quality of service (QoS) on the uplink. The uplink portion of the transmission path is the uplink over which the source device transmits directly to a second base station that is included in the overall path to the destination device. The auxiliary receiver may be used when the uplink to the second base station is degraded and additional uplink resources are available in the first base station. The improved QoS on the uplink portion also improves the QoS on the overall transmission path between the source device and destination device. When receiver resources are available in the first base station and QoS on the overall transmission path is degraded because of QoS degradation on the uplink portion, use of the first base station as an auxiliary receiver allows the available receiver resources of the first base station to be efficiently utilized to increase uplink QoS. This is advantageous in situations where receiver resources of the first base station that are not being used for primary base station operation would otherwise be idle and not utilized, while the uplink QoS suffered. The disclosed implementations avoid the situation in which unused but available receiver resources go idle while QoS suffers in a network.

Use of various implementations allows the determination of a need for the auxiliary resources to be performed at a location on the transmission path that is situated to efficiently determine the need. For example, in some situations the second base station may be best positioned to accurately determine that auxiliary resources are needed by determining that degradation on the uplink from the source device to the second base station is at a level that affects overall QoS on the transmission path between the source device and the destination device. This may be useful in a situation where the uplink connections of a network suffer from high interference. In this situation, the second base station that directly receives data transmissions from the source device on the uplink may perform the determination that uplink QoS is degraded by greater than a threshold amount. Upon determining that the uplink QoS is degraded by greater than the threshold amount, the second base station may send a request for auxiliary resources to the first base station. This implementation is efficient in that it does not require that the network infrastructure in the transmission path beyond the second base station be modified to use an auxiliary receiver. This may be useful when the first and second base station are controlled or managed by the same entity.

In other scenarios, the source device may have knowledge of QoS requirements for a type of data to be sent from an application on the source device over the uplink. The source device may also have knowledge that the QoS for the type of data to be sent may be affected by degradation caused by the limitations of the current resource allocation to the uplink, or interference conditions on the uplink. In an implementation, this knowledge may be advantageously used at the source device to determine if and when a request for additional uplink resources of an auxiliary receiver should be sent to the first base station. The source device may send the request for auxiliary resources to account for increases in QoS requirements that will occur. This may avoid degradation of the application data when the device begins to send the data. For example, a multimedia and/or video conferencing application operating on the source device may send the request for auxiliary resources when the application is to send high data rate multimedia/video on the uplink. These implementations do not require that the network infrastructure other than the first base station be modified to use an auxiliary receiver.

In further scenarios, a network device located on the transmission path between the second base station and the destination device may be best situated to determine that auxiliary resources are needed on the uplink from the source device to the second base station. In an implementation, the network apparatus may determine that QoS is degraded at the network apparatus's location beyond the first base station in the transmission path. Upon determining that QoS is degraded at the network apparatuses location, the network apparatus may send a request for auxiliary resources to the first base station. The redundant data stream received by the auxiliary receiver and sent through the network by the first base station may then provide redundancy along the transmission path. The redundancy may be utilized to allow the detected QoS degradation to be improved. This may be useful in a scenario in which the QoS is acceptable on the uplink portion between the source device and the second base station of the transmission path, but becomes degraded further along the transmission path. In that scenario, the QoS degradation would not be detected at the second base station but may be detected at the network apparatus. In examples, the network apparatus may be implemented in a network node/router, at the base station that is transmitting on a downlink to the destination device, or at the destination device.

In various implementations, the first base station may operate in a primary mode to provide conventional uplink and downlink communications to devices using, for example, any of the IEEE 802.11 Wi-Fi, 3rd Generation Cellular (3G), 4th Generation Cellular (4G), wide band code division multiple access (WCDMA), or Long Term Evolution (LTE) Cellular protocols. The term “base station” as used in this disclosure includes a base station, a terminal, an access point (AP), or any other apparatus that communicates with a wireless device to provide access to any type of network, for example, a cellular network, a Wi-Fi network, the internet, or a local access network (LAN).

The embodiments allow flexible operation of a base station as an auxiliary receiver. For example, in one implementation the auxiliary receiver may be configured in one or more base stations implemented as micro-base stations that cover an area such as a mall, a hotel, a transportation hub, or other similar public/private areas to provide service according to a cellular protocol. The term micro-base station as used in this specification means a low power base station that covers a relatively small area compared to conventional base stations. For example, while a conventional cellular base station may cover an area of up to 22 kilometers, a micro-base station may use power control to limit the radius of its coverage area. In one application, a micro-base station may provide coverage in an area of 2 kilometers or less (microcell). A micro-base station also includes a base station that provides coverage of an area on the order of 200 meters or less (picocell), or of an area of 10 meters or less (femtocell). Micro-base stations may be used to add network capacity in areas with very dense mobile device usage, such as train stations, and are often deployed temporarily during sporting events and other occasions in which extra capacity is known to be needed at a specific location in advance. Use of micro-base stations with power control implemented in wireless networks makes it easier to prevent interference from nearby cells using the same frequencies. By subdividing cells and creating more cells to help serve high density areas, a wireless network operator can optimize the use of spectrum and increase capacity.

In the micro-base station scenario, when cellular traffic is low and one or more of the micro-base stations are not being used, or not being fully utilized, the one or more unused micro-base stations may be used as auxiliary receivers. When used as an auxiliary receiver each of the one or more unused micro-base stations may receive a data stream sent on an uplink from a source device to an access point or base station and provide a redundant data stream at a destination device. Micro-base stations with auxiliary receiver capability may be implemented to add network capacity in areas with very dense mobile device usage. While these micro-base stations are primarily added to provide additional cellular coverage, the ability to configure the micro-base stations to function as auxiliary receivers may be utilized to enhance QoS for data streams sent on the uplinks of a network in such a situation. This allows the micro-base station receiver resources to be efficiently utilized.

In one example of a micro-base station implementation, the source devices that generate and send a data stream and the network access points/base stations that receive the data stream need not be aware of the auxiliary receiver operation. This allows flexible installation and removal of the micro-base stations in the coverage areas of networks in which the micro-base stations may operate as auxiliary receivers. In this case, the micro-base station may scan uplink transmissions in a network in order to determine what channels, protocols, or other parameters to use to receive the uplink transmissions as an auxiliary receiver.

In another example, access points/base stations in a network may be aware of the auxiliary receiver operation of the micro-base stations. In this case, applications may be installed on the access points/base stations and on the micro-base stations that allow information to be exchanged between the access points/base stations and micro-base stations to facilitate the operation of the micro-base stations as auxiliary receivers. For example, the access points/base stations may send requests to the micro-base station for resources for a particular protocol. In a further example, a network controller may be implemented to coordinate the operation of the micro-base stations as auxiliary receivers.

While implementations of the embodiments may be described as using micro-base stations, the embodiments may be implemented in networks using any type of base station, or combination of types of base stations, where the disclosed techniques may provide an advantage.

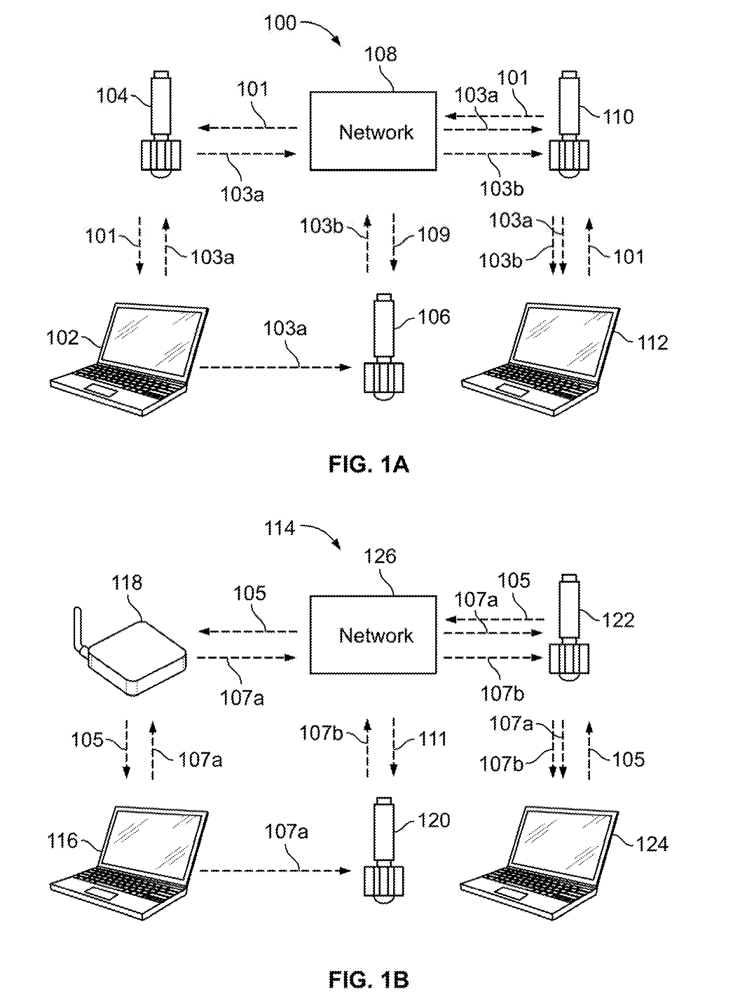

FIG. 1A is a diagram illustrating a system 100 including an example base station 106 operable as an auxiliary receiver. System 100 includes base station 104, base station 106, and base station 110. In an implementation of system 100, base station 104 and base station 106 may be implemented as 5G micro-base stations to serve a cellular network. Base station 104 may be, for example, part of a wireless cellular network. System 100 may also include base station 110, which may comprise a 5G base station, or another type of base station, as used in a wireless cellular network in which base station 110 serves. Base station 104 and base station 110 may each be part of a different wireless cellular network. Base stations 102, 106 and 110 may configured to communicate with one another through an infrastructure network 108 implemented, for example, by apparatus and communication paths through the internet.

In FIG. 1A, device 102 and device 112, which are shown as example laptop computers communicate with each other through infrastructure network 108 using base stations 104 and 110, respectively. In an example, device 102 and device 112 may be communicating data streams for user applications such as video/voice call applications or other multimedia applications that use high data rate transmissions. Device 102 is shown sending an uplink data transmission that includes data stream 103a to base station 104. Base station 104 then routes data stream 103a through the infrastructure network 108 to base station 110. Base station 110 then sends a downlink data transmission that includes data stream 103a to device 112. Device 102 is also shown receiving a downlink data transmission that includes data stream 101 from base station 104. Data stream 101 has originated at device 112 which sends an uplink data transmission including data stream 101 to base station 110. Base station 110 then forwards data stream 101 through the infrastructure network 108 to base station 104 for sending to device 102 in a downlink transmission.

In the implementation of FIG. 1A, base station 106 may operate as an auxiliary receiver to provide extra data redundancy and improve QoS for the applications on device 102 that are sending data stream 103a. When base station 106 has available resources, base station 106 may receive uplink data transmissions sent by device 102 to base station 104 that include data stream 103a. Base station 106 may then forward the data stream 103a, as received in the uplink data transmissions, onward as redundant data stream 103b through the infrastructure network 108. Redundant data stream 103b is then routed to base station 110. Base station 110 then sends a downlink data transmission that includes the redundant data stream 103b to device 112.

Device 112 may then combine the data streams 103a and 103b by utilizing the redundant data stream 103b for more accurate data decoding and better quality of service for the applications with which device 102 and device 112 are communicating. For example, in one implementation, device 112 may determine that data stream 103a and redundant data stream 103b are related by analyzing the source address of each data stream. The two data streams 103a and 103b may then be combined at the physical layer, provided to the network layer, and then provided to the destination application in device 112. The two data streams 103a and 103b may be combined using redundancy/error correction combining techniques. The combining may be done using, for example, selective combining, maximal ration combining, or equal gain combining.

In certain implementations, base station 106 may be configured with applications that control base station 106 to operate as an auxiliary receiver by communicating with other devices in the system. For example, base station 106 may be configured to communicate wirelessly, or through the infrastructure of network 108, with base station 104 so that base station 104 may send requests for auxiliary resources to base station 106, and so that base station 106 may respond appropriately. Base station 106 may also be configured to communicate with other devices in the network so that base station 106 may receive requests for resources from these other devices. For example, a network controller may be configured in the infrastructure network 108 to communicate with base station 106 so that requests for auxiliary resources may be received from the network controller. The network controller may be a device that manages resource use in the network that includes base station 104 and base station 106. In another example, base station 106 and device 102 may be configured to communicate with each other so that base station 106 may receive requests for auxiliary resources from device 102. In this example, device 102 may send requests for auxiliary resources based on uplink QoS reports received from base station 104. In these implementations, each of the communicating devices may be equipped with an application that allows each device to be aware of each other's location and/or address in the system (for example an IP address) and send/receive appropriate communication signals. In one implementation, an initial registration of base station 106 for setup of the communications with other devices in the system 100 may be performed upon installation/activation of base station 106. This may be performed by registering base station 106 with a network controller or with other base stations, such as base station 104.

In another example implementation, the operation of base station 106 to provide data redundancy to device 102 may be self-initiated at base station 106 without communicating with other devices when base station 106 has available resources. In this case, the operation of base station 106 may be transparent to device 104 and base station 102. Base station 106 may scan uplink transmissions in the network, select the data transmissions from device 104 that include data stream 103a, receive the data transmissions to generate the redundant data stream 103b, and forward the received redundant data stream 103b on through infrastructure network 108 to device 112 to provide redundancy. Base station 106 may select to receive the data transmissions that include data stream 103a based on the scanning results. For example, base station 106 may determine that the data transmissions from device 104 that include data stream 103a may be aided by redundancy. This determination may be based on the determination that the transmission channel carrying data stream 103a exhibits a high error rate or a low signal strength value when scanned. In another example, the determination may be based on determining that a large amount of interference exists in the transmission channel frequency band. Base station 106 may also be configured to scan uplink transmissions and determine the channel parameters and/or protocol used by device 102. Base station 106 may then receive data stream 103a at base station 106 on the appropriate channels, according to the determined protocol.

In another example, the scanning may be omitted and not performed. In this example, the auxiliary receiver channel parameters/protocol used by base station 106 during operation as an auxiliary receiver may be predefined and preprogrammed in base station 106. For example, the predefined auxiliary receiver channel parameters/protocol may cause base station 106 to receive on the transmission channel carrying data stream 103a when base station 106 has available receiver resources. Base station 106 may have information on a set of channels, in a network that is normally subject to interference from neighboring networks. The channels of this set of channels may be designated as channels that may benefit from the added redundancy provided by base station 106 operating as an auxiliary receiver. The set of channels may include the channel on which data stream 103a is sent. In this case, when operating as an auxiliary receiver, base station 106 may receive uplink data transmissions that include data stream 103a based on the information about the set of channels and send a received data stream onward as a redundant data stream to a destination device.

In one example implementation, base station 106 may also function to operate in a primary mode as a conventional 5G micro-base station to provide uplink/downlink communications through the internet with other 5G devices that move into the coverage area of base station 106. When there is small number of 5G devices or no 5G devices in the coverage area of base station 106 and receiver resources are available, base station 106 may configure itself to receive uplink data transmissions from device 102 that include data stream 103a, and provide the received data stream as redundant data stream 103b to device 112. This would take advantage of the unused resources of base station 106 and reduce the error rate associated with uplink transmissions from device 102 to base station 104.

In another example implementation, base station 106 may function as a dedicated auxiliary receiver for uplink transmissions of devices such as device 102. In this implementation, base station 106 may not have a conventional base station mode of operation but may be installed and configured to function only as an auxiliary receiver. For example, if QoS degrades in the RF environment of the network in which base station 104 is located because of long term interference or congestion, base station 106 may be installed in the network as a dedicated auxiliary receiver. In various examples of this implementation, base station 106 may communicate with base station 104 or device 102 to coordinate the provision of redundancy for uplink transmissions. In another example, base station 106 may be pre-configured to provide uplink redundancy to a designated base station or device without the designated base station or device being aware of the operation of base station 106 as an auxiliary receiver.

FIG. 1B is a diagram illustrating another system 114 including an example base station operable as an auxiliary receiver. System 114 includes base station 118, base station 120, and base station 122. In an implementation of system 114, base station 118 may be implemented as a Wi-Fi access point and base station 106 may be implemented as a 5G micro-base station that includes receiver resources that may be utilized to receive Wi-Fi transmissions. Base station 118 may be, for example, part of a corporate Wi-Fi network. System 114 may also include base station 122, which may comprise a 5G base station, or another type of base station, used in a wireless cellular network which base station 122 serves. Base stations 116, 120 and 122 may configured to communicate with one another through an infrastructure network 126 that is implemented, for example, using apparatus and communication paths through the internet.

In FIG. 1B, device 116 and device 124 communicate with each other through infrastructure network 108 using base stations 118 and 122. In an example, device 116 and device 124 may be communicating data streams for user applications such as video/voice call applications or other multimedia applications that use high data rate transmissions. Device 116 is shown sending an uplink data transmission that includes data stream 107a to base station 118. Base station 118 then routes data stream 107a through the infrastructure network 126 to base station 122. Base station 122 then sends a downlink data transmission that includes data stream 107a to device 124. Device 116 is also shown receiving a downlink data transmission that includes data stream 105 from base station 118. Data stream 105 has originated at device 124 which sends an uplink data transmission including data stream 105 to base station 122. Base station 122 then routes data stream 105 through the infrastructure network 126 to base station 118 for sending to device 116 in a downlink transmission.

In an implementation of FIG. 1B, base station 120 may operate as an auxiliary Wi-Fi receiver to provide extra data redundancy and improve QoS for the applications on devices 116 and 124 that are sending and receiving, respectively, data stream 107a. When base station 120 has available receiver resources that are unused for its 5G cellular operation, base station 106 may use the available resources to receive uplink Wi-Fi data transmissions sent by device 116 to base station 118 that include data stream 107a. Base station 120 then forwards the data stream 107a as received in the uplink data transmissions onward as redundant data stream 107b through the infrastructure network 108. Redundant data stream 107b is routed to base station 122. Base station 122 then sends a downlink data transmission that includes the redundant data stream 107b to base station 110.

Various implementations of base station 120 in FIG. 1B may operate similar to one or more of the implementations described in relation to base station 106 in FIG. 1A. Base station 120 may be configured to provide redundancy using a Wi-Fi protocol that is different than its normal cellular system protocol.

While FIGS. 1A and 1B have been described above using Wi-Fi and 5G as examples of protocols, the use of an auxiliary receiver according to the embodiments has application to any protocol or combination of protocols. For example, base stations 106 and 120 may operate to provide conventional uplink and downlink communications to devices in system 100 and system 114, respectively, using any of the IEEE 802.11 Wi-Fi, 3rd Generation Cellular (3G), 4^{th} Generation Cellular (4G), wide band code division multiple access (WCDMA), or Long Term Evolution (LTE) Cellular protocols. When operating as auxiliary receivers, base stations 106 and 120 may provide uplink support using one or more of above protocols.

Also, while shown as example laptop computers, devices 102, 112, 116, and 124 may any type of mobile device such as a smart phone or tablet computer. Each of the devices 102, 112,116, and 124 may also be alternatively implemented as any other type of device such as, for example, desktop PCs, gaming devices, media devices, smart televisions, home theater systems, smart automobile systems, smart house systems, multimedia cable/television boxes, smart phone accessory devices, tablet accessory devices, personal digital assistants (PDAs), portable media players, smart watches, smart sensors, or industrial control systems.

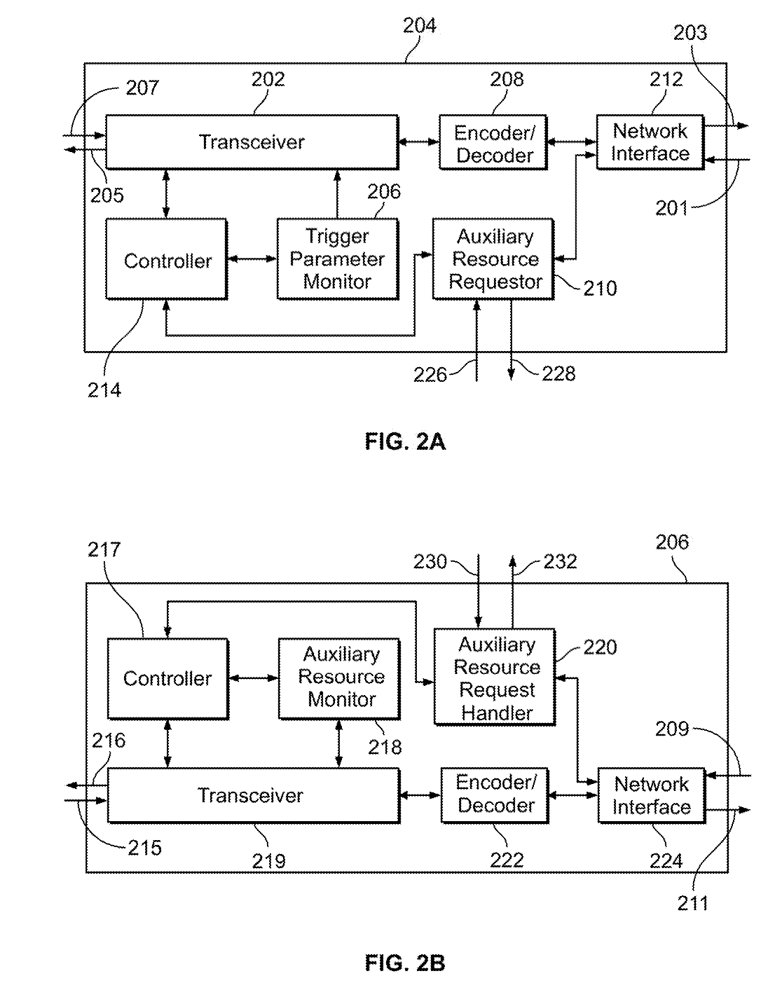

FIGS. 2A and 2B are simplified diagrams illustrating example base stations 204 and 206, respectively, which are configured according to implementations of the disclosure. The configuration of base station 204 of FIG. 2A may be utilized to implement base station 104 of FIG. 1A or base station 118 of FIG. 1B. The configuration of base station 206 of FIG. 2B may be utilized to implement base station 106 of FIG. 1A or base station 120 of FIG. 1B. Base station 204 is configured to request auxiliary resources from a network. Base station 206 is configured to provide auxiliary resources to a network.

Referring to FIG. 2A, base station 204 includes transceiver 202, encoder/decoder 208, network interface 212, controller 214, trigger parameter monitor 206, and auxiliary resources requestor 210. Controller 214 provides overall control of the various components of base station 204. Transceiver 202 may function to communicate with devices operating in a network by sending downlink transmissions on downlink 205 and receiving uplink transmissions on uplink 207. Downlink 205 and uplink 207 may each comprise one or more RF channels for carrying data associated with one or more devices. Network interface 212 may function to communicate with an infrastructure network by sending transmissions on link 203 and receiving transmissions on link 201. The infrastructure network may comprise a corporate infrastructure, the internet, or other type of network. For uplink transmissions received at base station 204, encoder/decoder 208 encodes the data received by transceiver 202 on uplink 207 into an appropriate network protocol for sending through network interface 212 over link 203 to an infrastructure network. Network interface 212 then sends the data onward. Network interface 212 may include capabilities for processing and routing the data encoded by encoder/decoder 208 to appropriate destinations. Network interface 212 may also receive data sent to base station 204 through the network infrastructure on link 201 and provide the data to encoder/decoder 208. Encoder/decoder 208 may decode data received from network interface 212 from the network protocol into a form that may be processed by transceiver 202. Transceiver 202 then may process the data for sending in downlink transmissions to a destination device on downlink 205. During the operation of base station 204, controller 214 may also control trigger parameter monitor 206 and auxiliary resources requestor 210 to request auxiliary resources for data transmissions received on uplink 207.

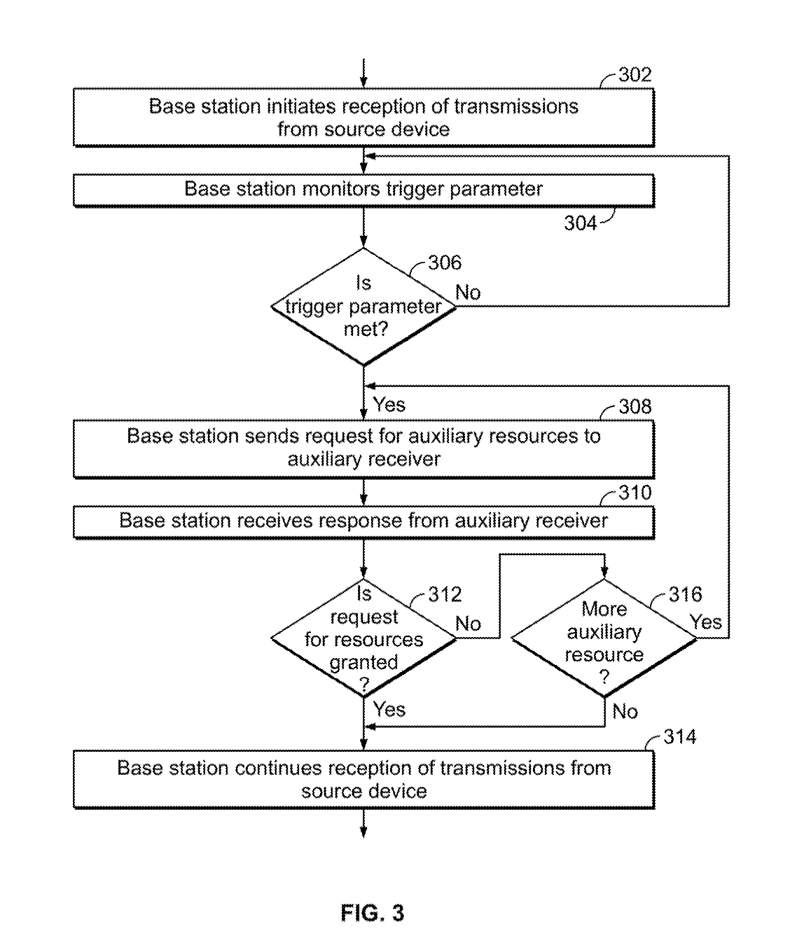

FIG. 3 is a flow diagram of operations that may be performed by an example base station when requesting auxiliary resources. FIG. 3 may be explained using base station 204 as an example of the base station referred to in FIG. 3.

The process begins at 302 where base station 204 initiates communications with a source device that is operating in the coverage area of base station 204. The initiation of communications includes initiating reception of uplink transmissions from the source device. At 304, during ongoing communications with the source device, controller 214 controls trigger parameter monitor 206 to perform monitoring of one or more QoS related trigger parameters. A trigger parameter, when met, will trigger a request for auxiliary resources. In an implementation, a trigger parameter may be a value associated with a QoS parameter for data transmissions received on uplink 207 from one or more devices, including the source device. A trigger parameter may be associated with uplink transmissions received from a particular device or from more than one device. A trigger parameter may comprise a value of an error rate, a channel interference level, or network interference level. When the value of the trigger parameter is exceeded, the trigger parameter may be considered met. For example, if an error rate rises above a trigger parameter value for an error rate, the trigger parameter is met. A trigger parameter may also comprise a value of a data rate or a received signal strength level that is met when the monitored value of a data rate or received signal strength falls below the value of the trigger parameter. For example, if a received signal strength level falls below a trigger parameter value of received signal strength, that trigger parameter is met. A trigger parameter may comprise a single value of a parameter. In other examples, a trigger parameter may comprise two or more values of different parameters that are used in a combined manner. When trigger parameters are used in a combined manner, it may be determined that a trigger parameter is met only when all of the combined trigger parameter values are met, or, alternatively, when only one of the trigger parameter values is met.

At 306, trigger parameter monitor 206 determines if the trigger parameter is met. If the trigger parameter is not met the process returns to 304 and continues to monitor the one or more trigger parameters. If the trigger parameter is met, the process move to 308 and trigger parameter monitor 206 provides an indication of the trigger parameter being met to controller 214. At 308, controller 214 may then control auxiliary resource requester 210 to send a request for auxiliary resources to a base station capable of providing the auxiliary resources. For example, auxiliary resource requestor 210 may send a request for auxiliary resources to a base station configured as base station 206 of FIG. 2B. The request for auxiliary resources may be sent by any appropriate communications method. For example, auxiliary resources requestor 210 may send the request through network interface 112 on link 203 to the network infrastructure 108, which routes the request for auxiliary resources to base station 206. In another example, auxiliary resource requestor 210 may have Wi-Fi transceiver capability. In that case, the request for auxiliary resources may be sent by a Wi-Fi transceiver implemented in auxiliary resource requestor 210 to base station 206 on link 228. At base station 206, the request for auxiliary resources may be received on link 232 by a Wi-Fi transceiver implemented in auxiliary resource request handler 220.

At 310, auxiliary resource requestor 210 receives a response to the request for auxiliary resources sent at 308. The response to the auxiliary resource request may be received using the same communication method by which it was sent. For example, if auxiliary resource requestor 210 sent the request through network interface 212, the response may be received on link 201 at network interface 212. If the request for auxiliary resources was sent on link 228 by a Wi-Fi transceiver implemented in auxiliary resource requestor 210, the response to the request for auxiliary resources may be received on link 226 by the Wi-Fi transceiver implemented in auxiliary resource requester 210.

At 312, controller 214 determines if the request for auxiliary resources was granted. If the request was granted the process moves to 314. At 314, base station 204 continues communications with the source device. Auxiliary resources will now be provided for the uplink transmissions of the source device by the base station granting the request for auxiliary resources.

If the request was not granted the process moves to 316. At 316, controller 214 determines if another base station/auxiliary receiver exists to which a request for auxiliary resources may be sent. If no other base station/auxiliary receiver exists, the process moves to 314 and base station 204 continues communications with the source device without auxiliary resources. If another base station/auxiliary receiver exists, the process returns to 308 and controller 214 controls auxiliary resource requestor 210 to send a request for auxiliary resources to another base station/auxiliary receiver. Operations 308, 310, 312, and 316 may be repeated to request resources from different base station/auxiliary receivers until a positive response to a request for auxiliary resources is received from a base station/auxiliary receiver able to provide the requested resources. If, in repeating operations 308, 310, 312, and 316, a negative response is received from all known base stations having auxiliary receiver capability, no additional requests for auxiliary resources are sent. The process moves to 314 and base station 204 continues communications with the source device without auxiliary resources. The process may return to 304 from 314 after a period of time.

Referring again to FIG. 2B, base station 206 includes transceiver 219, encoder/decoder 222, network interface 224, controller 217, auxiliary resource monitor 218, and auxiliary resource request handler 220. Controller 217 provides overall control of the various components of base station 206. Transceiver 219 may function to communicate with devices in a network by sending downlink transmissions on downlink 215 and receiving uplink transmissions on uplink 216. Downlink 215 and uplink 216 may each comprise one or more RF channels for carrying data associated with one or more devices. Network interface 224 may function to communicate with an infrastructure network by sending transmissions on link 211 and receiving transmissions on link 209. The infrastructure network may comprise a corporate infrastructure, the interact, or other type of network. For uplink transmissions received at base station 206, encoder/decoder 222 encodes the data received by transceiver 215 on uplink 216 into an appropriate network protocol and provides the encoded data to network interface 224. Network interface 224 then sends the data to a network infrastructure over link 211. Network interface 224 may include capabilities for processing and routing the data encoded by encoder/decoder 222 to appropriate destinations. Network interface 224 may also receive data sent from the network infrastructure on link 209 to base station 206 and provide the data to encoder/decoder 222. Encoder/decoder 222 may decode the data from a network protocol form into a form that may be processed by transceiver 219. Transceiver 219 then may process the data for sending in downlink transmissions to a destination device on downlink 215. In an implementation of base station 206, auxiliary resource monitor 218 monitors the receiver resource use of base station 206. For example, auxiliary resource monitor 218 may monitor the activities of transceiver 219 and update, periodically or otherwise, a resource database that includes available receiver resources for use as an auxiliary receiver.

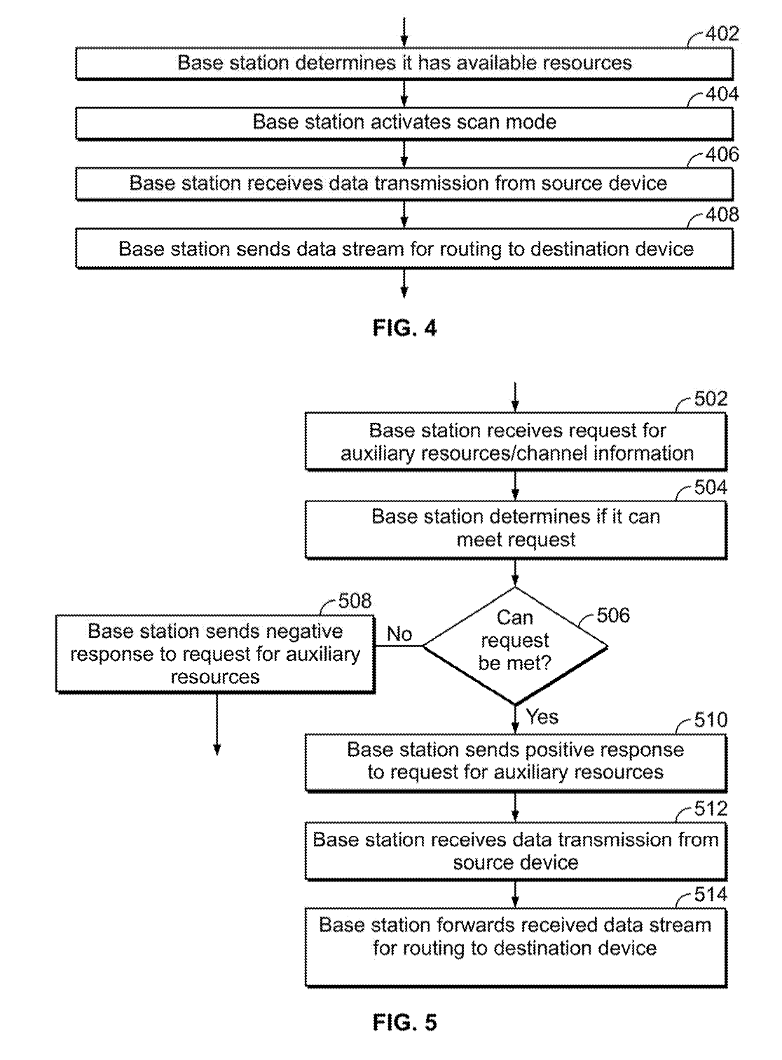

FIG. 4 is a flow diagram of operations performed by an example base station that includes an auxiliary receiver. The flow diagram of FIG. 4 may be explained by using base station 206 of FIG. 2B as an example of the base station in the flow diagram. In the implementation of FIG. 4, base station 206 may self-initiate operation as an auxiliary receiver. In this case, the function of base auxiliary resource request handler 220 may be omitted from base station 206.

The process begins at 402 where base station 206 determines that it has available resources for operations as an auxiliary receiver. Controller 217 of base station 206 may perform the determination at 402 based on an indication provided by auxiliary resource monitor 218. Auxiliary resource monitor 218 may monitor the receiver resource usage of base station 206 as it performs its normal operations and keep a resource database. The resource database may include information on available receiver resources that are free for auxiliary receiver use. The information may comprise available channels, available frequency bands, overall load on receiver resources, or other information associated with the ability of transceiver 219 to provide receiver capability for use as an auxiliary receiver. The resource database may be updated on a predetermined time schedule. Also, other information such as knowledge of data traffic patterns over time may be incorporated into the resource database for use in decision making. Based on the information in the resource database, auxiliary resource monitor 218 may provide an indication to controller 217 that auxiliary resources are available. The indication provided to controller 217 may include information comprising the length of a time period during which the auxiliary resources will be available.

At 404, controller 217 may then control transceiver 219 to begin operation in a scan mode. In scan mode, controller 217 controls transceiver 219 to scan a range of uplink transmissions at base station 106. Controller 217 may then select, based on the scanning results, one or more uplink transmissions that may be aided by redundancy. In one example, controller 217 may select an uplink transmission/channel that exhibits a high error rate or a low signal strength value when scanned. In another example, controller 217 may select an uplink transmission/channel that is affected by a large amount of interference. In an implementation, base station 206 may utilize 802.11r network functions to verify the uplink transmissions it will receive.

At 406, controller 217 may then control transceiver 219 to receive, based on the results of the scan, uplink data transmissions on uplink 216 that include a data stream sent from a source device addressed to a destination device. Encoder/decoder 222 then encodes the data stream received by transceiver 219 into an appropriate network protocol for sending through network interface 224 over link 211 to an infrastructure network. At 408 network interface 224 then sends the data stream onward as a redundant data stream to the destination device.

In another implementation of FIG. 4, the data transmissions that are received by the transceiver 219 may be determined and selected from information available to controller 217 without the need to scan. In this case operation 404 may be omitted. For example, controller 217 may have information on a set of channels in a network that are normally subject to interference from neighboring networks, where the channels may benefit from the added redundancy provided by base station 206. In this case controller 217 may control transceiver 219 to receive uplink data transmissions on one or more of those channels and send a received data stream onward as a redundant data stream to a destination device.

FIG. 5 is a flow diagram of operations performed by another example base station that includes an auxiliary receiver. FIG. 5 may be explained by using base station 206 of FIG. 2B as an example base station.

The process begins at 502 where base station 206 receives a request for auxiliary resources. For example, base station 206 may receive a request for auxiliary resources from auxiliary resource requestor 210 of base station 204. The request for auxiliary resources may be provided to auxiliary request handler 220 by network interface 224 which receives the request for auxiliary resources on link 209. Alternatively, the request for auxiliary resources may be received by a Wi-Fi transceiver that is implemented in auxiliary request handler 220 on link 230. The request for auxiliary resources may include channel information that is associated with the channels for which the resources are requested. In another example, base station 206 may receive a request for auxiliary resources from a device such as computing device 102 of FIG. 1A, or from a network controller implemented in network infrastructure such as network infrastructure 108 of FIG. 1A.

At 504, upon receiving a request for auxiliary resources, auxiliary request handler 220 may communicate with controller 217 and/or auxiliary resource monitor 218 to determine if base station 206 may meet the request for auxiliary resources based on the information in a resource database. The process then moves to 506.

If base station 206 is able to meet the request for auxiliary resources, the process moves from 506 to 510. At 510, auxiliary request handler 220 may send a positive response to the requesting base station or device. The response to the auxiliary resource request may be sent using the same communication method by which it was received. For example, if the request for auxiliary resources was received from the network infrastructure on link 209, auxiliary request handler 220 may send the response to network interface 224, which sends the response on link 211 to the requesting base station or device. If the request for auxiliary resources was received on link 230 over Wi-Fi, auxiliary request handler 220 may send the response on link 232 using the Wi-Fi transceiver implemented in auxiliary request handler 220. The positive response informs the requesting base station or device that base station 206 will be able to provide auxiliary resources.

If base station 206 is not able to meet the request for auxiliary resources, the process moves from 506 to 508. At 508, auxiliary request handler 220 sends a negative response to the requesting base station or device, and the process ends. The negative response informs the requestor that it may send a request for auxiliary resources to another base station that provides auxiliary receiver functions to attempt to obtain the requested resources.

In the case in which base station 206 is able to meet the request for auxiliary resources, the process moves from 510 to 512. At 512, controller 217 may control transceiver 219 to receive, based on information included in the request for auxiliary resources, uplink data transmissions on uplink 215 that include a data stream sent from a source device addressed to a destination device. Encoder/decoder 222 then encodes the data stream received by transceiver 219 into an appropriate network protocol. The encoded data stream is then provided to network interface 224. At 514, network interface 224 then sends the data stream onward on link 211 as a redundant data stream for the destination device.

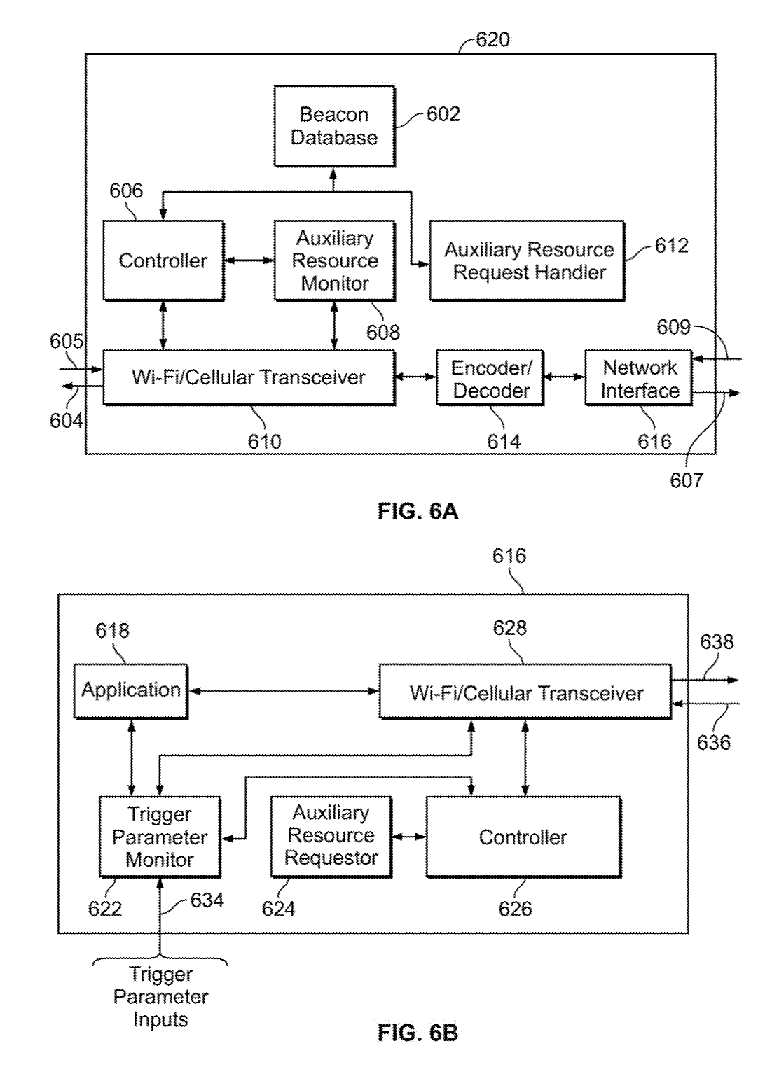

FIGS. 6A and 6B are simplified diagrams illustrating an example base station 620 and a device 616, respectively, which are configured according to implementations of the disclosure. The configuration of base station 620 of FIG. 6A may be utilized to implement base station 116 of FIG. 1B. The configuration of device 616 of FIG. 6B may be utilized to implement device 110 of FIG. 1B. Device 616 is configured to request auxiliary resources from a network. Base station 620 is configured to provide auxiliary resources to a network.

Referring to FIG. 6A, base station 620 includes Wi-Fi/cellular transceiver 610, encoder/decoder 614, network interface 616, controller 606, auxiliary resource monitor 608, beacon database 602, and auxiliary resource request handler 612. Controller 606 provides overall control of the various components of base station 620. Wi-Fi/cellular transceiver 610 may function to communicate with devices in a network by sending downlink transmissions on downlink 604 and receiving uplink transmissions on uplink 605. Downlink 604 and uplink 605 may each comprise one or more RF channels, configured according to Wi-Fi or cellular protocols, for carrying data associated with one or more devices. Network interface 616 may function to communicate with an infrastructure network by sending transmissions on link 607 and receiving transmissions on link 609. The infrastructure network may comprise a corporate infrastructure, the internet, or other type of network. For uplink transmissions received at base station 620, encoder/decoder 614 encodes the data received by Wi-Fi/cellular transceiver 610 on uplink 605 into an appropriate network protocol and provides the encoded data to network interface 616. Network interface 616 then sends the data to a network infrastructure over link 607. Network interface 616 may include capabilities for processing and routing the data encoded by encoder/decoder 614 to appropriate destinations. Network interface 616 may also receive data sent from the network infrastructure on link 609 to base station 620 and provide the data to encoder/decoder 614. Encoder/decoder 614 may decode the data from network protocol form into a form that may be processed by Wi-Fi/cellular transceiver 610. Wi-Fi/cellular transceiver 610 then may process the data for sending in downlink transmissions, to a destination device on downlink 604. In an implementation of base station 620, auxiliary resource monitor 608 monitors the receiver resource use of base station 620. For example, auxiliary resource monitor 608 may monitor the activities of Wi-Fi/cellular transceiver 610 and update, periodically or otherwise, a resource database that includes available receiver resources for auxiliary receiver use.

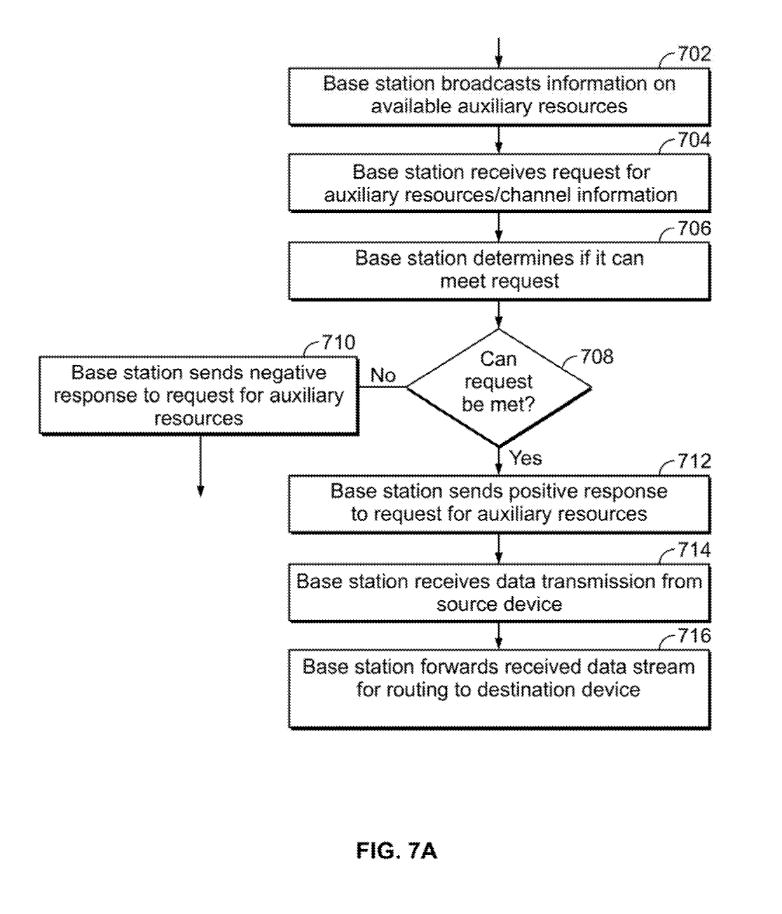

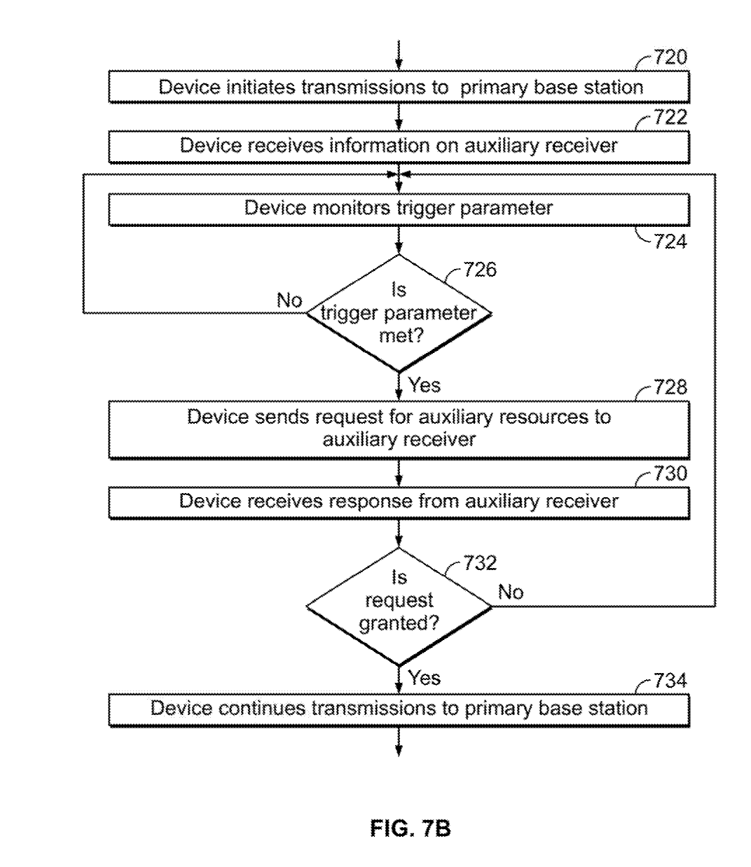

FIG. 7A is a flow diagram of operations performed by another example base station that includes an auxiliary receiver. FIG. 7 may be explained by using base station 620 of FIG. 6A as an example base station.

The process begins at 702 where base station 620 broadcasts information about available auxiliary resources on a beacon. At 702, controller 606 may obtain information from beacon database 602 about the available auxiliary resources in base station 620. Controller 606 may then control Wi-Fi/cellular transceiver 610 to broadcast the information to devices operating in the network in which base station 620 is implemented. The broadcast may be performed on a Wi-Fi beacon channel. In an implementation, the information in beacon database 602 may include information about the protocol/channel capabilities of base station 620 to function as an auxiliary receiver. For example, the information that is broadcast may comprise protocol/channel information. The protocol/channel information may inform devices operating in the network that base station 620 may provide auxiliary resources in one or more Wi-Fi protocols, or in a cellular protocol, on one or more sets of channels.

At 704, base station 620 receives a request for auxiliary resources. The request for auxiliary resources may include channel information about the channels for which the requesting device desires auxiliary resources. For example, base station 620 may receive the request for auxiliary resources from a device operating in the network that sends the request after receiving information about base station 620 on the Wi-Fi beacon. The request for auxiliary resources may be sent on a Wi-Fi channel as a signal addressed to the base station. The request for auxiliary resources may be received by Wi-Fi/cellular transceiver 610 and provided to auxiliary request handler 612 by controller 606. At 706, upon receiving the request for auxiliary resources, auxiliary request handler 612 may communicate with controller 606 and/or auxiliary resource monitor 608 to determine if base station 620 may meet the request for auxiliary resources based on the information in a resource database.

The process then moves to 708. If base station 620 is able to meet the request for auxiliary resources, the process moves from 708 to 712. At 712, auxiliary request handler 612 may inform controller 606 to control Wi-Fi/cellular transceiver 610 to send a positive response to the requesting base station or device. The response to the auxiliary resource request may be sent by the same communication method by which it was received. For example, the response may be sent on a Wi-Fi channel as a signal directed to the requesting device. The positive response informs the requesting device that base station 620 will be able to provide auxiliary resources.

If base station 620 is not able to meet the request for auxiliary resources, the process moves from 708 to 710. At 710, auxiliary request handler 220 sends a negative response to the requesting base station or device, and the process ends. The negative response informs the requestor that it may send a request for auxiliary resources to another base station that provides auxiliary receiver functions to attempt to obtain the requested resources.

In the case in which base station 620 is able to meet the request for auxiliary resources, the process moves from 712 to 714. Controller 606 may then control Wi-Fi/cellular transceiver 610 to receive, based on information included in the request for auxiliary resources, uplink Wi-Fi data transmissions on uplink 605. The uplink Wi-Fi data transmissions include a data stream sent from the requesting device to a base station other than base station 620, and addressed to a destination device. Encoder/decoder 614 then encodes the data stream received by Wi-Fi/cellular transceiver 610 into an appropriate network protocol. The encoded data stream is then provided to network interface 616. At 716, network interface 616 then sends the data stream onward on link 607 as a redundant data stream for the destination device.

Referring again to FIG. 6B, device 616 includes Wi-Fi/cellular transceiver 628, application 618, controller 626, trigger parameter monitor 622, and auxiliary resource requestor 624. Controller 626 provides overall control of the various components of device 161. Wi-Fi/cellular transceiver 628 may function to communicate with base stations operating in a network by receiving downlink transmissions on downlink 636 and sending uplink transmissions on uplink 638. Downlink 636 and uplink 638 may each comprise one or more RF channels for carrying data associated with one or more devices. Application 618 may comprise an application of one or more applications on device 616 that provides data for uplink transmissions and/or receives data from downlink transmissions. Application 618 may provide one or more data streams to Wi/Fi cellular transceiver 628 for sending on uplink 638 to a base station of the network in which device 616 is operating. Wi/Fi cellular transceiver 628 may also receive data transmissions on downlink 636 sent from one or more base stations, and provide one or more data streams included in the data transmissions to application 618. During the operation of device 616, controller 626 may also control trigger parameter monitor 622 and auxiliary resource requestor 624 to request auxiliary resources for data transmissions that are sent on uplink 638.

FIG. 7B is a flow diagram of example operations performed by an example device configured to request additional resources from an auxiliary receiver. FIG. 7B is a flow diagram of operations that may be performed by an example device when requesting auxiliary resources. FIG. 7B may be explained using device 616 as an example of the device referred to in FIG. 7B.

The process begins at 720 where device 616 initiates communication with a base station responsible for the coverage area in which device 616 is operating. The initiation of communications may include initiating uplink transmissions from device 616 that include a data stream being sent from application 618 to an application on a destination device. For example, application 618 may include a multimedia/conferencing application that is sending a high data rate video stream on the uplink 638 to a destination device through the network. Application 618 may also receive a data stream over downlink 636 that is sent to device 616 from the multimedia/conferencing application on the destination device. In an implementation, the uplink and downlink transmissions of links 636 and 638 may be according to a Wi-Fi protocol.

At 722, Wi/Fi cellular transceiver 628 of device 616 may receive a Wi-Fi beacon signal and provide information about auxiliary resources received in the Wi-Fi beacon signal to controller 626. The Wi-Fi beacon signal may be sent by a base station configured similar to base station 616 of FIG. 6A. The Wi-Fi beacon may include information associated with the base station's capability to function as an auxiliary receiver. The information received on the beacon may include protocol/channel information as was described as being sent from base station 620 during operation 702 of FIG. 7A

At 724, during the ongoing operation of device 616, controller 626 controls trigger parameter monitor 622 to perform monitoring of one or more QoS related trigger parameters. The trigger parameters used in implementations of FIG. 7B may be similar to the trigger parameters described for operation 304 of FIG. 3. Additionally, in another implementation of device 616, application 618 may also function to generate indications of one or more trigger parameters being met to trigger parameter monitor 622. Application 618 may monitor one or more conditions associated with the function of application 618, and signal to trigger parameter monitor 622 that a trigger parameter is met based on the monitoring. For example, application 618 may monitor its functions as it communicates with another application on a destination device. When application 618 determines that it is going to send data requiring a high level of QoS, it may provide an indication to trigger parameter monitor 622 that a trigger parameter is met. For example, if application 618 is a video conferencing application, it may determine that the user of device 616 is preparing to play a high quality presentation video for a conference call participant at the destination device. When application 618 determines that high data rate/high QoS data is to be sent, it may send an indication to trigger parameter monitor 622 that a trigger parameter is met. Additionally, trigger parameter monitor 622 may be configured to receive trigger parameter inputs at input 634 from a user interface. In this configuration, a user of device 616 may manually cause trigger parameter monitor 622 to determine that a trigger parameter has been met. For example, if a user has a large amount of data to upload through the network to a destination device the user may create an input at input 634 that causes trigger parameter monitor 622 to determine that a trigger parameter has been met.

As the monitoring is performed at 724, trigger parameter monitor 622 may determine, at 726, if any of the one or more trigger parameters are met. If a trigger parameter is not met the process returns to 724, and trigger parameter monitor 622 continues to monitor the one or more trigger parameters. If the trigger parameter is met, the process move to 728 and trigger parameter monitor 622 provides an indication of the trigger parameter being met to auxiliary resource requestor 624. At 728, auxiliary resource requestor 624 may then cause controller 626 to control Wi/Fi cellular transceiver 628 to send a request for auxiliary resources to a base station capable of providing the auxiliary resources. For example, auxiliary resource requestor 624 may send a request for auxiliary resources to a base station that identified itself in a Wi-Fi beacon as being able to provide auxiliary resources using a Wi-Fi protocol compatible with the protocol used by device 616. The request for auxiliary resources may be sent on a Wi-Fi channel configured on uplink 638 as a signal addressed to the base station identified by the beacon signal.

At 730, auxiliary resource requestor 624 receives a response to the auxiliary resource request sent at 728. The response to the auxiliary resource request may be received on a Wi-Fi channel configured on downlink 636. A positive response informs device 616 that base station 620 will be able to grant the request and provide auxiliary resources. A negative response informs device 616 that base station 620 will not be able to provide auxiliary resources.

At 732, controller 626 determines if the response to the request for auxiliary resources was granted, that is, it determines if the response is positive. If the request was granted the process moves to 734. At 734, device 616 continues communications with the primary base station. Auxiliary resources will now be provided for the uplink transmissions of device 616 by the base station that granted the request for auxiliary resources.

If the request was not granted the process moves to 724 and device 616 continues operations. At 724, trigger parameter monitor 622 may continue to monitor the one or more trigger parameters. In this case, because a negative response was received, trigger parameter monitor 622 may wait for a selected time period until it initiates another request for auxiliary resources. If the negative response was received in response to a request for auxiliary resources initiated by a selected application of application 618, that selected application of applications 618 may continue to indicate to trigger parameter monitor 622 that a trigger parameter is met as long as the condition meeting the trigger parameter continues. For example, if a video conferencing application initiated the request for auxiliary resources based on high QoS being needed, the video conferencing application may continue to indicate to trigger parameter monitor 622 that a trigger parameter is met until the high QoS is no longer needed.

In another implementation, auxiliary resource requestor 624 may have information that multiple beacon signals have been received indicating that more than one base station has indicated it is capable of providing auxiliary resources to device 616. In this implementation, operations 728, 730, and 732 may be repeated, to request resources from different base stations until a positive response to a request for auxiliary resources is received from a base station able to provide the requested resources. If, in repeating operations 728, 730, and 732, a negative response is received from all known base stations having auxiliary receiver capability, the process then may move back to 724.

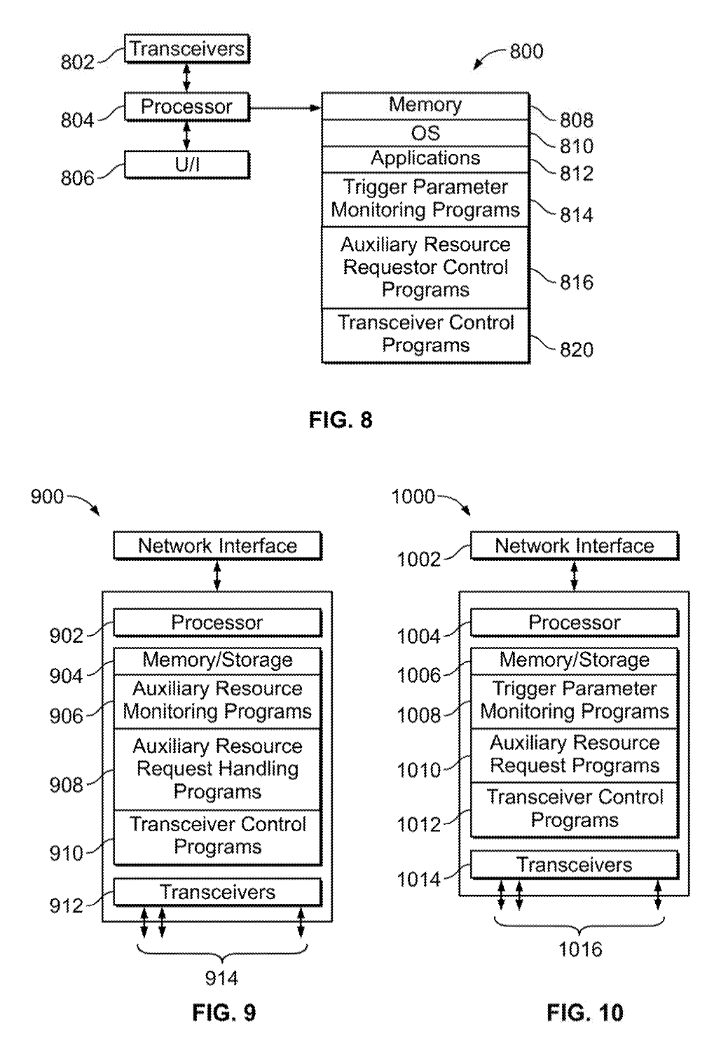

FIG. 8 is a simplified block diagram showing an example device 800 operable to request auxiliary resources. Device 800 may represent an implementation of device 616 of FIG. 6B. Device 800 includes transceivers 802, processor 804, user interfaces (U/I) 806, and memory 800. Memory 800 includes code and instructions for operating system (OS) 810, applications 812, trigger parameter monitoring programs 814, auxiliary resource requestor control programs 816, and transceiver control programs 820.

Processor 804 may comprise one or more processors, or other control circuitry, or any combination of processors and control circuitry that provide overall control of device 800 according to the disclosed embodiments. Memory 808 may be implemented as any type of as any type of computer readable storage media, including non-volatile and volatile memory. The programs/code for OS 810 controls the general operation of device 800. The U/I 806 allow a user to interface with device 800 to receive/input data and information from/to device 800.

In various implementations, execution of trigger parameter monitoring programs 814, auxiliary resource requestor control programs 816, transceiver control programs 820, and applications 812 cause device 800 to perform the operations shown and described in relation to FIG. 6B and FIG. 7B.

FIG. 9 is a simplified block diagram showing an example base station 900 including an auxiliary receiver. Base station 900 represents a possible implementation of base stations 206 and 620 of FIGS. 2B and 6A, respectively. Base station 900 includes processor 902, transceivers 912, and memory/storage 904. Memory/storage 904 includes code and instructions for auxiliary resource monitoring programs 906, auxiliary resource request handling programs 908, and transceiver control programs 910.

Processor 902 may comprise one or more processors, or other control circuitry or any combination of processors and control circuitry that provide overall control of base station 900 according to the disclosed embodiments. Memory/storage 904 may be implemented as any type of as any type of computer readable storage media, including non-volatile and volatile memory.

In the embodiments, execution of transceiver control programs 910 causes processor 902 to implement operations that cause base station 900 to perform appropriate operations to operate as a base station according to wireless communications protocol. Execution of auxiliary resource monitoring programs 906 allows processor 902 to determine if base station 900 has available resources to use as an auxiliary receiver. Auxiliary resource request handling programs 908 allow request for auxiliary resources sent from another device to be processed. Transceiver control programs 910, auxiliary resource monitoring programs 906, and auxiliary resource request handling programs 908 function together to provide an auxiliary receiver function in base station 900. Auxiliary resource request handling programs 908 may be omitted in an implementation that self-initiates operation as an auxiliary receiver, such as the implementation of FIG. 3.

In various implementations, execution of auxiliary resource monitoring programs 906, auxiliary resource request handling programs 908, and transceiver control programs 910, allows base station 900 to perform the operations shown and described in relation to FIGS. 4, 5, and 7A.

FIG. 10 is a simplified block diagram showing an example base station 1000 that is operable to request auxiliary resources. Base station 1000 represents a possible implementation of base station 204 of FIG. 2A. Base station 1000 includes processor 1004, transceivers 1014, and memory/storage 1006. Memory/storage 1006 includes code and instructions for auxiliary resource request programs 1010, trigger parameter monitoring programs 1008, and transceiver control programs 1012.

Processor 1004 may comprise one or more processors, or other control circuitry or any combination of processors and control circuitry that provide overall control of base station 900 according to the disclosed embodiments. Memory/storage 1004 may be implemented as any type of as any type of computer readable storage media, including non-volatile and volatile memory.

In the embodiments, execution of transceiver control programs 1012 causes processor 1004 to implement operations that cause base station 1000 to perform appropriate operations to operate as a base station according to wireless communications protocol. Execution of auxiliary resource request programs 1010 allows processor 902 to initiate requests to other devices for auxiliary resources. Trigger parameter monitoring programs 1008 allow requests for auxiliary resources to be initiated based on conditions in base station 1000. Transceiver control programs 1012, auxiliary resource request programs 1010, and trigger parameter monitoring programs 1008 function together to provide functions that allow base station 1000 to appropriately request auxiliary resources.

In various implementations, execution of auxiliary resource monitoring programs 906, auxiliary resource request handling programs 908, and transceiver control programs 910, allows base station 900 to perform the operations shown and described in relation to FIG. 3.

The disclosed implementations include a first base station comprising a receiver, one or more processors in communication with the receiver, and memory in communication with the one or more processors, the memory comprising code that, when executed, causes the one or more processors to control the first base station to initiate operation of the first base station as an auxiliary receiver, operate as the auxiliary receiver to receive a data transmission sent on an uplink configured between a source device and a second base station, generate a first data stream from the received data transmission; and, send the first data stream through a network to a destination device, wherein the first data stream is redundant to a second data stream sent by the second base station to the destination device. The code may cause the first base station to initiate operation as the auxiliary receiver by causing the one or more processors to control the first base station to monitor at least one parameter at the first base station, and initiate operation as the auxiliary receiver based on the monitoring of the at least one parameter. The at least one parameter may comprise an indication of available resources. The initiation of operation as an auxiliary receiver may comprise scanning the uplink configured between the source device and the second base station to determine the data transmission to be received in operation as the auxiliary receiver. The initiation of operation as an auxiliary receiver may comprise receiving a request for auxiliary resources. The initiation of operation as an auxiliary receiver may further comprise determining that the base station is able to meet the request for auxiliary resources. The request for auxiliary resources may comprise channel information. The first base station may further comprise a transmitter in communication with the one or more processors, and, the code, when executed, may further causes the one or more processors to control the first base station to send, from the transmitter, a response to the request for auxiliary resources indicating that auxiliary resources have been provided. The request for auxiliary resources may be received from the source device. The request for auxiliary resources may be received from the second base station. The initiation of operation as an auxiliary receiver may comprise broadcasting information indicating one or more capabilities of the first base station to operate as an auxiliary receiver. The initiation of operation as an auxiliary receiver may further comprises receiving a request for auxiliary resources based on the one or more capabilities of the first base station to operate as an auxiliary receiver.

The disclosed implementations also include a device comprising a transceiver, one or more processors in communication with the transceiver, and memory in communication with the one or more processors, the memory comprising code that, when executed, causes the one or more processors to control the device to receive information associated with an auxiliary receiver in a broadcast signal, send data transmissions on an uplink to a base station, determine that resources are needed for the data transmissions; and, send a request for auxiliary resources to the auxiliary receiver based on the determination that the resources are needed. The device may determine that the auxiliary resources are needed for the data transmissions based on uplink QoS parameters received from the base station. The device may receive the information associated with the auxiliary receiver in a Wi-Fi beacon signal. An application on the device may determine that the auxiliary resources are needed based on a type of data to be sent from the application. The auxiliary receiver may comprise a fast auxiliary receiver and the code, when executed, further causes the one or more processors to control the device to receive a negative response to the request for auxiliary resources from the first auxiliary receiver, the negative response indicating that the auxiliary resources cannot be provided, and send the request for the auxiliary resources to a second auxiliary receiver.

The disclosed implementations further include a base station comprising a transceiver, one or more processors in communication with the transceiver, and memory in communication with the one or more processors, the memory comprising code that, when executed, causes the one or more processors to control the base station to setup a uplink and a downlink for communications with a device, transmit downlink data transmissions to the device, receive uplink data transmissions from the device, determine that auxiliary resources are needed for the uplink data transmissions, and send a request for the auxiliary resources to auxiliary receiver. The base station may determine that the auxiliary resources are needed by monitoring a parameter of the uplink data transmissions. The auxiliary receiver may comprise a first auxiliary receiver and the code, when executed, may further causes the one or more processors to control the base station to receive a negative response to the request for the auxiliary resources from the first auxiliary receiver, the negative response indicating that the auxiliary resources cannot be provided by the first auxiliary receiver, and send the request for auxiliary resources to a second auxiliary receiver.

Although the subject matter has been described in language specific to structural features and/or methodological acts, it is to be understood that the subject matter defined in the appended claims is not necessarily limited to the specific features or acts described above. Rather, the specific features and acts described above are disclosed as example embodiments, implementations, and forms of implementing the claims and these example configurations and arrangements may be changed significantly without departing from the scope of the present disclosure. Moreover, although the example embodiments have been illustrated with reference to particular elements and operations that facilitate the processes, these elements, and operations may be combined with or, be replaced by, any suitable devices, components, architecture or process that achieves the intended functionality of the embodiment. Numerous other changes, substitutions, variations, alterations, and modifications may be ascertained to one skilled in the art and it is intended that the present disclosure encompass all such changes, substitutions, variations, alterations, and modifications as falling within the scope of the appended claims.

What is claimed is:

1. A first base station comprising:
one or more processors; and,
memory in communication with the one or more processors, the memory comprising code that, when executed, causes the one or more processors to control the first base station to:
initiate operation of the first base station as an auxiliary receiver;
receive a data transmission sent on an uplink configured between a source device and a second base station during operation as the auxiliary receiver;
generate a first data stream from the received data transmission; and,
send the first data stream through a network to a destination device, wherein the first data stream is redundant to a second data stream sent by the second base station to the destination device.

2. The first base station of claim 1, wherein the code causes the first base station to initiate operation as the auxiliary receiver by causing the one or more processors to control the first base station to:
monitor at least one parameter at the first base station; and,
initiate operation as the auxiliary receiver based on the monitoring of the at least one parameter.

3. The first base station of claim 2, wherein at least one parameter comprises an indication of available resources.

4. The first base station of claim 1, wherein the initiation of operation as an auxiliary receiver comprises scanning the uplink configured between the source device and the second base station to determine the data transmission to be received in operation as the auxiliary receiver.

5. The first base station of claim 1, wherein the initiation of operation as an auxiliary receiver comprises receiving a request for auxiliary resources.

6. The first base station of claim 5, wherein the initiation of operation as an auxiliary receiver further comprises determining that the first base station is able to meet the request for auxiliary resources.

7. The first base station of claim 5, wherein the request for auxiliary resources comprises channel information.

8. The first base station of claim 5, wherein, the code, when executed, further causes the one or more processors to control the first base station to send a response to the request for auxiliary resources indicating that auxiliary resources have been provided.

9. The first base station of claim 5, wherein the request for auxiliary resources is received from the source device.

10. The first base station of claim 5, wherein the request for auxiliary resources is received from the second base station.

11. The first base station of claim 1, wherein the initiation of operation as an auxiliary receiver comprises broadcasting information indicating one or more capabilities of the first base station to operate as an auxiliary receiver.

12. The first base station of claim 11, wherein the initiation of operation as an auxiliary receiver further comprises receiving a request for auxiliary resources based on the one or more capabilities of the first base station to operate as an auxiliary receiver.

13. A device comprising:
one or more processors; and,
memory in communication with the one or more processors, the memory comprising code that, when executed, causes the one or more processors to control the device to:
receive information associated with an auxiliary receiver in a broadcast signal;
send data transmissions on an uplink to a base station;
determine that auxiliary resources are needed for the data transmissions; and,
send a request for auxiliary resources to the auxiliary receiver based on the determination that the auxiliary resources are needed.

14. The device of claim 13, wherein the device determines that the auxiliary resources are needed for the data transmissions based on uplink Qos parameters received from the base station.

15. The device of claim 13, wherein the device receives the information associated with the auxiliary receiver in a Wi-Fi beacon signal.

16. The device of claim 13, wherein an application on the device determines that the auxiliary resources are needed based on a type of data to be sent from the application.

17. The device of claim 16, wherein the auxiliary receiver comprises a first auxiliary receiver and the code, when executed, further causes the one or more processors to control the device to:
receive a negative response to the request for auxiliary resources from the first auxiliary receiver, the negative response indicating that the auxiliary resources cannot be provided; and,
send the request for auxiliary resources to a second auxiliary receiver.

18. A base station comprising:
one or more processors; and,
memory in communication with the one or more processors, the memory comprising code that, when executed, causes the one or inure processors to control the base station to:
set up an uplink for communications with a device;
receive uplink data transmissions from the device;
determine that auxiliary resources are needed for the uplink data transmissions; and,
send a request for auxiliary resources to an auxiliary receiver based on the determination that auxiliary resources are needed.

19. The base station of claim 8, wherein the base station determines that the auxiliary resources are needed by monitoring a parameter of the uplink data transmissions.

20. The base station of claim 18, wherein the auxiliary receiver comprises a first auxiliary receiver and wherein the code, when executed, further causes the one or more processors to control the base station to:
receive a negative response to the request for the resources from the first auxiliary receiver, the negative response indicating that the auxiliary resources cannot be provided by the first auxiliary receiver; and,
send the request for auxiliary resources to a second auxiliary receiver.
